(19) United States
(12) Patent Application Publication
(10) Pub. No.: US 2013/0330512 A1
(43) Pub. Date: Dec. 12, 2013

(54) UNIQUE MATERIAL FOR FORMING DISPENSING CARTONS

(71) Applicants: Jerry Ray Stephens, Hamilton, OH (US); Paris Nicolle Jackson, Forest Park, OH (US); Monica Ho-Kleinwaechter, Loveland, OH (US)

(72) Inventors: Jerry Ray Stephens, Hamilton, OH (US); Paris Nicolle Jackson, Forest Park, OH (US); Monica Ho-Kleinwaechter, Loveland, OH (US)

(21) Appl. No.: 13/493,208

(22) Filed: Jun. 11, 2012

(51) Int. Cl. B32B 27/10; D04H 13/00; D21H 27/00; B32B 33/00

(52) U.S. Cl. 428/141; 442/327; 162/100

(57) ABSTRACT

A material for forming a container suitable for containing stacked and/or interfolded sheet materials is described. The material is formed from a fibrous structure bonded to a film material. The material has a Surface Elevation value of greater than 26.2 μm.

### FIELD OF THE INVENTION

The present disclosure relates to materials useful for dispensing packages and cartons for stacked and/or interfolded sheet materials such as facial tissues. More particularly, this disclosure pertains to a unique material for forming packages and cartons having an eco-friendly environmental footprint and an improved tactile feel that are configured to dispense stacked and interfolded sheets.

### BACKGROUND OF THE INVENTION

Packages for containing and dispensing stacked and/or interleaved sheet materials are generally formed from carton board cartons and other rigid materials. These cartons are common in everyday use and are found in a plurality of bathrooms and other rooms with in the household. These paperboard or carton board constructions are usually rigid parallelpiped constructions with graphics printed upon the outer surfaces thereof. Most consumers will state that these cartons are hard, smooth-surfaced, have fixed graphics, and are frankly, boring.

Typically, such cartons are provided and formed from a blank shown made from foldable paperboard or similar sheet-like material. The containers typically have a top surface, a bottom surface, and opposed lateral side panels. All panels are hingedly connected along parallel horizontal fold lines. The blank is typically adapted to be folded into a rectangular tubular configuration and as such comprises a typical end-load carton.

The top surface of the traditional carton has formed therein a panel which is defined by an endless line of separation and which is adapted to be removed by breaking that frangible line of separation in a conventional manner. The end closures of the carton are formed by inwardly foldable closure flaps. This can include minor flaps connected to the side panels of the carton at the opposite ends of the side panel. These end flaps, or minor flaps, each can be provided with a cut-away portion to allow exposure of a portion of the major flaps that are hingedly attached to the opposite ends of the top surface along the hinge lines. These major flaps are foldable downwardly over the ends of the carton and completely cover the ends of the carton. The carton blank may be assembled in any conventional manner. A glue flap can be provided along one lateral edge and connected along a hinge line to the bottom surface to serve as a manufacturer's glue flap.

Such cartons can generally be divided into two principal types. The first type enables stacked and interfolded sheets to “pop-up” to dispense through an opening in the top wall of the carton. Such pop-up dispensers provide partial withdrawal of the next successive tissue upon pulling sheets out one at a time from the carton. The second type of carton facilitates dispensing of a stack of sheets that are generally not interfolded by providing an opening in one at least one of the carton walls to enable a user to reach into the carton and remove one or more of the sheets at a time. This latter type of carton is commonly known as a “reach-in” carton. Typically, a reach-in carton does not facilitate “pop-up” dispensing of successive sheets. Such containers are provided in U.S. Pat. Nos. 3,144,961 and 3,272,385.

Frankly, innovation in the carton art has been rather stagnant until now.

Thus, it would be understood by one of skill in the art that it would be clearly beneficial to provide a carton for dispensing stacked and/or interleaved sheet materials, such as facial tissues that provides no drawback from the current manner in which consumers dispense the material disposed therein, but is produced from a limited amount of resources thus decreasing the environmental footprint of the carton. Eliminating such non-decomposable packaging materials would indeed require fewer manufacturing steps and be eco-friendly by not requiring additional natural resource materials.

Further it would be understood by one of skill in the art that it would be clearly beneficial to provide a carton for dispensing stacked and/or interleaved sheet materials, such as facial tissues that provides the consumer with a more ergonomic container having a better tactile feel than currently marketed paperboard containers. It would also be understood by one of skill in the art that it would be clearly beneficial to provide a carton for dispensing stacked and/or interleaved sheet materials, such as facial tissues that reduces the environmental footprint by reducing the environmental footprint at the time of disposal

### SUMMARY OF THE INVENTION

The present disclosure describes a material for forming a container suitable for containing stacked and/or interfolded sheet materials. The material is formed from a fibrous structure bonded to a film material. The material has a Surface Elevation value of greater than 26.2 μm.

The present disclosure also describes a material for forming a container suitable for containing stacked and/or interfolded sheet materials. The material is formed from a fibrous structure bonded to a film material. The material has a plate stiffness ranging from about 1.4 N*mm to about 200 N*/mm.

The present disclosure further describes a material for forming a container suitable for containing stacked and/or interfolded sheet materials. The material comprises a fibrous structure. The fibrous structure has a normalized compression caliper to compression pressure relationship expressed by the equation y=−0.0681 n(x)+1.2219.

### BRIEF DESCRIPTION OF THE DRAWINGS

FIG. 1 is a perspective view of an exemplary embodiment of a carton of the present disclosure;

FIG. 2 is a cross-sectional view of the packaging material suitable for forming the carton of FIG. 1 taken along the line 2-2 of FIG. 1;

FIG. 3 is a cross-sectional view of the carton of FIG. 1 taken along the line 3-3;

FIG. 4 is a graphical representation of mathematically expressed equations for exemplary laminated and non-laminated structures where x=Compression Pressure and y=Normalized Compression Caliper; and,

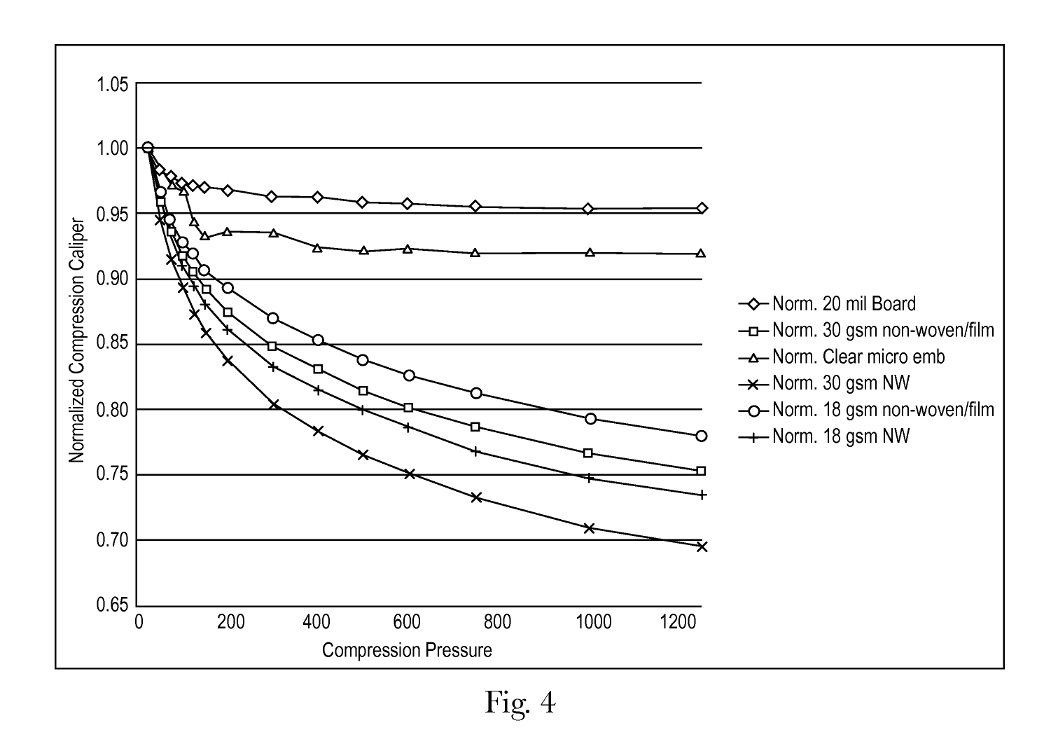

FIG. 5 is a graphical representation of mathematically expressed equations for exemplary laminated and non-laminated structures where x=Relaxation Pressure and y=Normalized Relaxation Caliper.

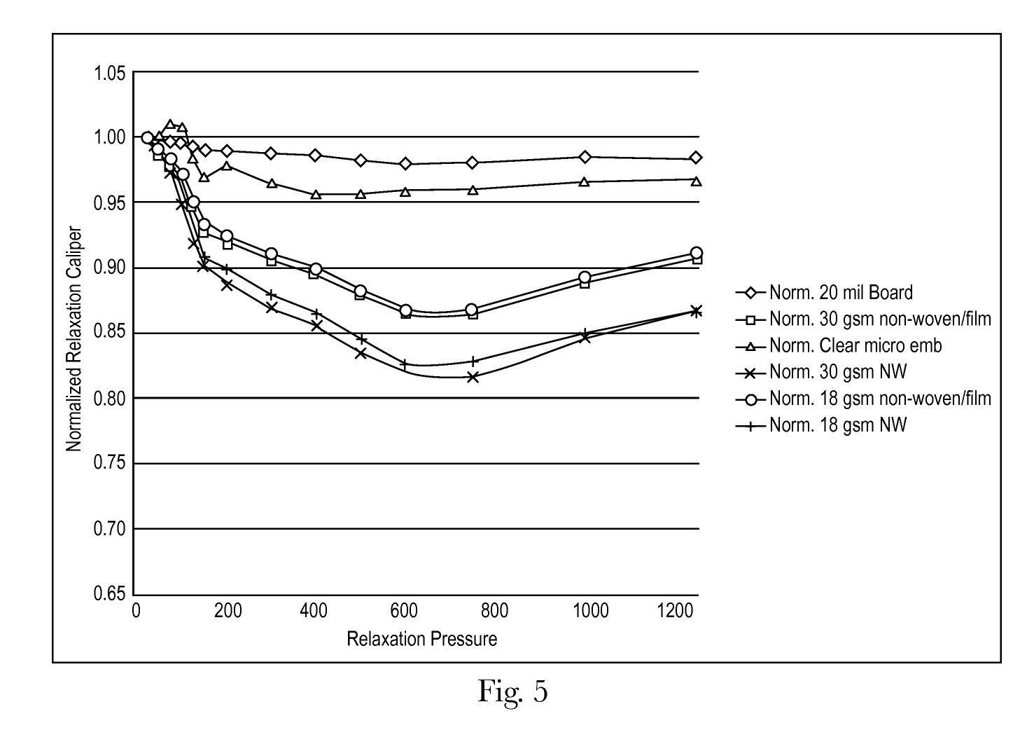

### DETAILED DESCRIPTION OF THE INVENTION

The present disclosure provides for a material suitable for the formation of cartoning useful for containing sanitary tissue products. The material generally comprises a fibrous structure laminated to a film having high bulk and loft on to the fibrous structure layer to form a composite fabric.

“Basis Weight” as used herein is the weight per unit area of a sample reported in lbs/3000 ft² or g/m² (gsm) and is measured according to the Basis Weight Test Method described herein described herein.

“Caliper” as used herein means the macroscopic thickness of a fibrous structure. Caliper is measured according to the Caliper Test Method described herein described herein.

“Co-formed fibrous structure(s)” provide for a fibrous structure to comprise a mixture of at least two different materials. At least one of the materials comprises a filament, such as a polypropylene filament, and at least one other material, different from the first material, comprises a solid additive, such as a fiber and/or a particulate. In one example, a co-formed fibrous structure comprises solid additives, such as fibers, such as wood pulp fibers, and filaments, such as polypropylene filaments.

“Cross Machine Direction” or “CD” as used herein means the direction parallel to the width of the fibrous structure making machine and/or sanitary tissue product manufacturing equipment and perpendicular to the machine direction.

“Density” as used herein is calculated as the quotient of the Basis Weight of a fibrous structure expressed in gsm divided by the Caliper of the fibrous structure expressed in microns. The resulting Density of a fibrous structure is expressed as g/cm³.

As used herein, a “fibrous structure” is a structure that comprises one or more filaments and/or fibers suitable for producing cartoning useful for containing sanitary tissue products. In one non-limiting example, a fibrous structure can be an orderly arrangement of filaments and/or fibers within a structure that perform a function. Non-limiting examples of fibrous structures may include paper and/or fabrics (e.g., including woven, knitted, and non-woven structures).

Non-limiting examples of processes for making fibrous structures include wet-laid processes, air-laid processes, spun-bond processes, weaving processes, melt-blown processes, and extrusion processes. Some processes may include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous slurry is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

Fibrous structures may be homogeneous or may be layered. If layered, the fibrous structures may comprise at least two and/or at least three and/or at least four and/or at least five layers. Fibrous structures may also be co-formed fibrous structures.

A “fiber” and/or “filament” is an elongate particulate having an apparent length greatly exceeding its apparent width (e.g., an aspect ratio of greater than 1). For purposes of the present disclosure, a “fiber” can be an elongate particulate that exhibits a length of less than 5.08 cm (2 in.) and a “filament” can be an elongate particulate that exhibits a length of greater than or equal to 5.08 cm (2 in.).

Fibers are typically considered discontinuous in nature. Non-limiting examples of fibers include wood pulp fibers and synthetic staple fibers such as polyester fibers.

Filaments are typically considered continuous or substantially continuous in nature. Filaments are relatively longer than fibers. Non-limiting examples of filaments include melt-blown and/or spun-bond filaments. Non-limiting examples of materials that can be spun into filaments include natural polymers, such as starch, starch derivatives, cellulose and cellulose derivatives, hemicellulose, hemicellulose derivatives, and synthetic polymers including, but not limited to polyvinyl alcohol filaments and/or polyvinyl alcohol derivative filaments, and thermoplastic polymer filaments, such as polyesters, nylons, polyolefins such as polypropylene filaments, polyethylene filaments, and biodegradable or compostable thermoplastic fibers such as polylactic acid filaments, polyhydroxyalkanoate filaments and polycaprolactone filaments. The filaments may be monocomponent or multicomponent, such as bicomponent filaments.

In one non-limiting example, a “fiber” refers to papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web as described in U.S. Pat. Nos. 4,300,981 and 3,994,771. Also applicable to the present invention are fibers derived from recycled paper, which may contain any or all of the above categories as well as other non-fibrous materials such as fillers and adhesives used to facilitate the original papermaking.

In addition to the various wood pulp fibers, other cellulosic fibers such as cotton linters, rayon, lyocell and bagasse can be used in this invention. Other sources of cellulose in the form of fibers or capable of being spun into fibers include grasses and grain sources.

“Film materials” is intended to include foils, polymer sheets, co-extrusions, laminates, and combinations thereof. Film materials are preferably fabricated from a polymer that does not have adhesive characteristics, which may be made from homogeneous resins or blends thereof. The properties of a selected film materials can include, though are not restricted to, combinations or degrees of being: porous, non-porous, microporous, gas or liquid permeable, non-permeable, hydrophilic, hydrophobic, hydroscopic, oleophilic, oleophobic, high critical surface tension, low critical surface tension, surface pre-textured, elastically yieldable, plastically yieldable, electrically conductive, and electrically non-conductive. Such materials can be homogeneous or composition combinations.

Film materials may be made from homogeneous resins or blends thereof. Single or multiple layers within the film structure are contemplated, whether co-extruded, extrusion-coated, laminated or combined by other known means. The key attribute of the film material is that it be formable to produce protrusions and valleys. Useful resins include, but are not limited to, polyethylene (PE), polypropylene (PP), polyethylene terephthalate (PET), polyvinyl chloride (PVC), polyvinylidene chloride (PVDC), latex structures, nylon, etc. Polyolefins are generally preferred due to their lower cost and ease of forming but are not necessary to practice the invention. High density polyethylene (HDPE) is most preferred to fabricate the film sheet. Other suitable materials to fabricate the film from include, but are not limited to, aluminum foil, coated (waxed, etc.) and uncoated paper, coated and uncoated wovens, scrims, meshes, nonwovens, and perforated or porous films, and combinations thereof. In a particularly preferred embodiment, the flexible film sheet material is a formed film from about 0.0001 inch to about 0.005 inches, more preferably about 0.001 inch thick film.

“Machine Direction” or “MD” as used herein means the direction parallel to the flow of the fibrous structure through the fibrous structure making machine and/or sanitary tissue product manufacturing equipment.

“Plies” as used herein means two or more individual, integral fibrous structures disposed in a substantially contiguous, face-to-face relationship with one another, forming a multi-ply fibrous structure and/or multi-ply sanitary tissue product. It is also contemplated that an individual, integral fibrous structure can effectively form a multi-ply fibrous structure, for example, by being folded on itself.

“Ply” as used herein means an individual, integral fibrous structure.

“Sanitary tissue product” means a soft, low density (e.g., less than about 0.15 g/cm³) web useful as a wiping implement for post-urinary and post-bowel movement cleaning (toilet tissue), for otorhinolaryngological discharges (facial tissue), and multi-functional absorbent and cleaning uses (absorbent towels).

The sanitary tissue product may be segmented into individual segments of sanitary tissue products having discrete lengths. These individual segments of sanitary tissue products can then be folded upon itself and subsequently stacked and/or interleaved. Such stacked and/or interleaved sanitary tissue products can then be inserted into appropriate packaging consistent with the present disclosure. Packages for containing and dispensing stacked and/or interleaved sheet materials disposed inside carton board cartons can generally be divided into two principal types. The first type enables stacked and interfolded sheets to “pop-up” to dispense through an opening in the top wall of the carton. Such pop-up dispensers provide partial withdrawal of the next successive tissue upon pulling sheets out one at a time from the carton. The second type of carton facilitates dispensing of a stack of sheets that are generally not interfolded by providing an opening in one at least one of the carton walls to enable a user to reach into the carton and remove one or more of the sheets at a time. This latter type of carton is commonly known as a “reach-in” carton.

Alternatively, sanitary tissue products may be convolutely wound upon itself about a core or without a core to form a sanitary tissue product roll. Lines of perforation can be provided within the length of the wound product to facilitate separation of adjacent portions of the convolutely wound sanitary tissue product.

In one non-limiting example, a sanitary tissue product may exhibit a basis weight of greater than 15 g/m² (9.2 lbs/3000 ft²) to about 120 g/m² (73.8 lbs/3000 ft²) and/or from about 15 g/m² (9.2 lbs/3000 ft²) to about 110 g/m² (67.7 lbs/3000 ft²) and/or from about 20 g/m² (12.3 lbs/3000 ft²) to about 100 g/m² (61.5 lbs/3000 ft²) and/or from about 30 g/m² (18.5 lbs/3000 ft²) to 90 g/m² (55.4 lbs/3000 ft²). In addition, the sanitary tissue products and/or fibrous structures of the present invention may exhibit a basis weight between about 40 g/m² (24.6 lbs/3000 ft²) to about 120 g/m² (73.8 lbs/3000 ft²) and/or from about 50 g/m² (30.8 lbs/3000 ft²) to about 110 g/m² (67.7 lbs/3000 ft²) and/or from about 55 g/m² (33.8 lbs/3000 ft²) to about 105 g/m² (64.6 lbs/3000 ft²) and/or from about 60 g/m² (36.9 lbs/3000 ft²) to 100 g/m² (61.5 lbs/3000 ft²).

In another non-limiting example, a sanitary tissue product may exhibit a total dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in). In addition, the sanitary tissue product of the present invention may exhibit a total dry tensile strength of greater than about 196 g/cm (500 g/in) and/or from about 196 g/cm (500 g/in) to about 394 g/cm (1000 g/in) and/or from about 216 g/cm (550 g/in) to about 335 g/cm (850 g/in) and/or from about 236 g/cm (600 g/in) to about 315 g/cm (800 g/in). In one example, the sanitary tissue product exhibits a total dry tensile strength of less than about 394 g/cm (1000 g/in) and/or less than about 335 g/cm (850 g/in).

In still another non-limiting example, a sanitary tissue product may exhibit a total dry tensile strength of greater than about 196 g/cm (500 g/in) and/or greater than about 236 g/cm (600 g/in) and/or greater than about 276 g/cm (700 g/in) and/or greater than about 315 g/cm (800 g/in) and/or greater than about 354 g/cm (900 g/in) and/or greater than about 394 g/cm (1000 g/in) and/or from about 315 g/cm (800 g/in) to about 1968 g/cm (5000 g/in) and/or from about 354 g/cm (900 g/in) to about 1181 g/cm (3000 g/in) and/or from about 354 g/cm (900 g/in) to about 984 g/cm (2500 g/in) and/or from about 394 g/cm (1000 g/in) to about 787 g/cm (2000 g/in).

In yet another non-limiting example, a sanitary tissue product may exhibit an initial total wet tensile strength of less than about 78 g/cm (200 g/in) and/or less than about 59 g/cm (150 g/in) and/or less than about 39 g/cm (100 g/in) and/or less than about 29 g/cm (75 g/in).

In another non-limiting example, a sanitary tissue product may exhibit an initial total wet tensile strength of greater than about 118 g/cm (300 g/in) and/or greater than about 157 g/cm (400 g/in) and/or greater than about 196 g/cm (500 g/in) and/or greater than about 236 g/cm (600 g/in) and/or greater than about 276 g/cm (700 g/in) and/or greater than about 315 g/cm (800 g/in) and/or greater than about 354 g/cm (900 g/in) and/or greater than about 394 g/cm (1000 g/in) and/or from about 118 g/cm (300 g/in) to about 1968 g/cm (5000 g/in) and/or from about 157 g/cm (400 g/in) to about 1181 g/cm (3000 g/in) and/or from about 196 g/cm (500 g/in) to about 984 g/cm (2500 g/in) and/or from about 196 g/cm (500 g/in) to about 787 g/cm (2000 g/in) and/or from about 196 g/cm (500 g/in) to about 591 g/cm (1500 g/in).

In a further non-limiting example, a sanitary tissue product may exhibit a density (measured at 95 g/in²) of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The fibrous structures and/or sanitary tissue products of the present invention may comprises additives such as softening agents, temporary wet strength agents, permanent wet strength agents, bulk softening agents, lotions, silicones, wetting agents, latexes, especially surface-pattern-applied latexes, dry strength agents such as carboxymethylcellulose and starch, and other types of additives suitable for inclusion in and/or on sanitary tissue products.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

“Wet Burst” as used herein is a measure of the ability of a fibrous structure and/or a sanitary tissue product incorporating a fibrous structure to absorb energy, when wet and subjected to deformation normal to the plane of the fibrous structure and/or fibrous structure product and is measured according to the Wet Burst Test Method described herein.

### Packaging Material

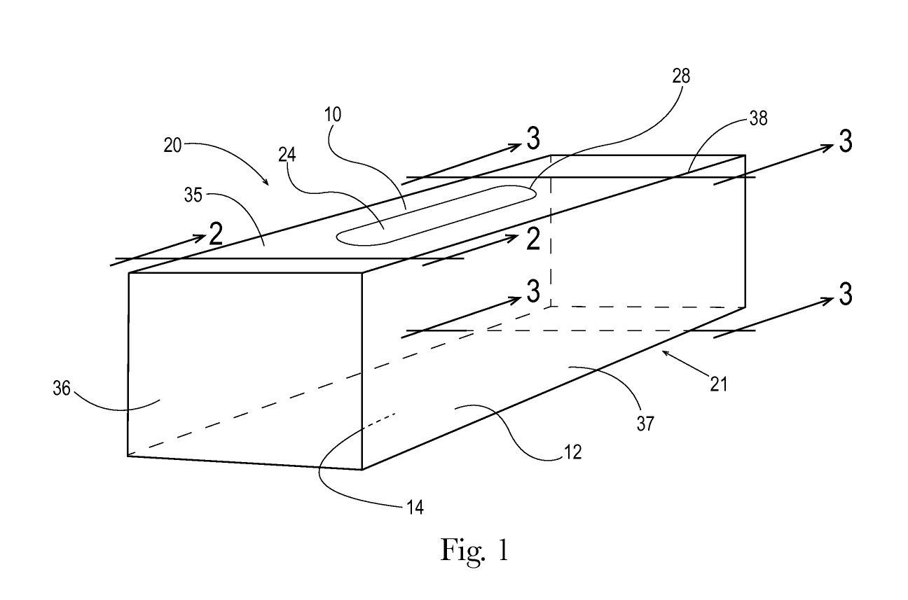

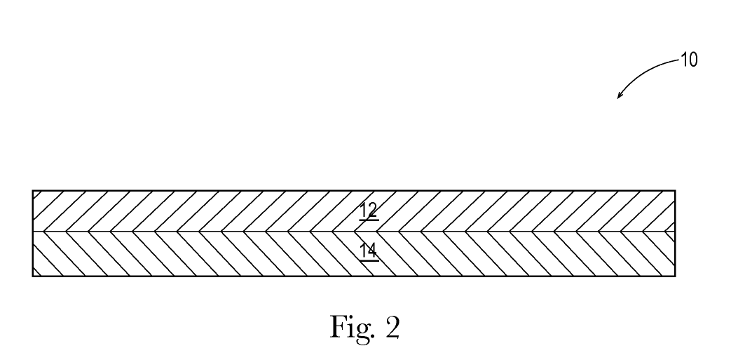

As shown in FIGS. 1 and 2, a packaging material 10 suitable for the container of the present invention provides a fibrous structure 12 laminated and/or otherwise bonded (e.g., chemically, physically, electrostatically, adhesively, melt-bonded, and the like) to a film material 14. In a preferred embodiment, the fibrous structure 12 generally provides the surface of the resulting packaging material 10 with high bulk and loft. In a preferred embodiment, the film material 14 provides the resulting packaging material 10 with a generally liquid impervious characteristic.

It is also believed that providing the film material 14 in contacting engagement with the fibrous structure 12 provides the resulting packaging material 10 with enhanced stiffness.

### The Container

As shown in FIGS. 1-3, an exemplary, but non-limiting, package 20 of the present disclosure is provided as a container having a parallelpiped geometry and a generally rectangular footprint. One of skill in the art will easily understand the current container can form virtually any shape and/or geometry desired to provide the required dispensing of products provided within the confines of package 20. This may include, for example, ovular containers, cylindrical containers, triangular containers, as well as containers having any polygonal shape or structure.

Exemplary package 20 generally provides a carton 21 containing a bundle 16 of sheets 22 of stacked and/or interleaved facial tissue paper. However, one of skill in the art will easily recognize that virtually any product can be contained in the exemplary carton discussed herein. This may include by way of non-limiting example, bath tissue, paper toweling, feminine care products, baby care products, household care products, and the like. In an exemplary, but non-limiting embodiment, the carton 21 is provided with a dispensing opening 24 disposed upon one or more sides of container 21 which is provided as a composite having any geometry that facilitates the dispensing of the sheets 16 from the carton 21. In one preferred embodiment, the dispensing opening 24 can be provided as a generally elongate oval-shaped slot. A lineament 28 can enable the tear-out removal of a panel disposed in carton 21 that has been outlined by a line of weakening having the configuration of lineament 28. For purposes of convention only, the dispensing opening will be considered to be disposed in the uppermost side or sides of the container 21 as this is how most consumers would position such a carton 21 for the dispensing of any article contained within carton 21. However, one of skill in the art could position the dispensing opening upon any side or sides of the container 21 and still provide the dispensing necessary from carton 21 for the articles contained therein.

As shown, the exemplary paralellpiped carton 21 preferably comprises top wall 35, end wall 36, front (side) wall 37, corresponding back (side) wall (not shown), corresponding second end wall (not shown), and corresponding bottom wall (not shown). The top-front edge of the carton is designated 38.

One of skill in the art will recognize that if carton 21 is provided with an alternative geometry, naturally, the number of sides, walls, tops, and bottom designations will reflect the actual geometry of the carton 21. For example, if carton 21 is provided as an elliptic cylinder (i.e., having an elliptical cross-section) there would naturally be a top wall, bottom wall, and at least one side wall circumscribing the top and bottom walls. Similarly, if carton 21 is provided as a vertically oriented wedge, there would naturally be a bottom wall and at least four side walls, all of which culminate in a line segment joining all four sides.

An exemplary embodiment of package 20 comprises a carton 21 that is sized and configured to accommodate a bundle of stacked and/or interleaved sheets 22. Such a carton 21 is preferably constructed from the unique packaging material 10 described herein. However, one of skill in the art could provide for the construction of carton 21 from a material comprising only fibrous structure 12.

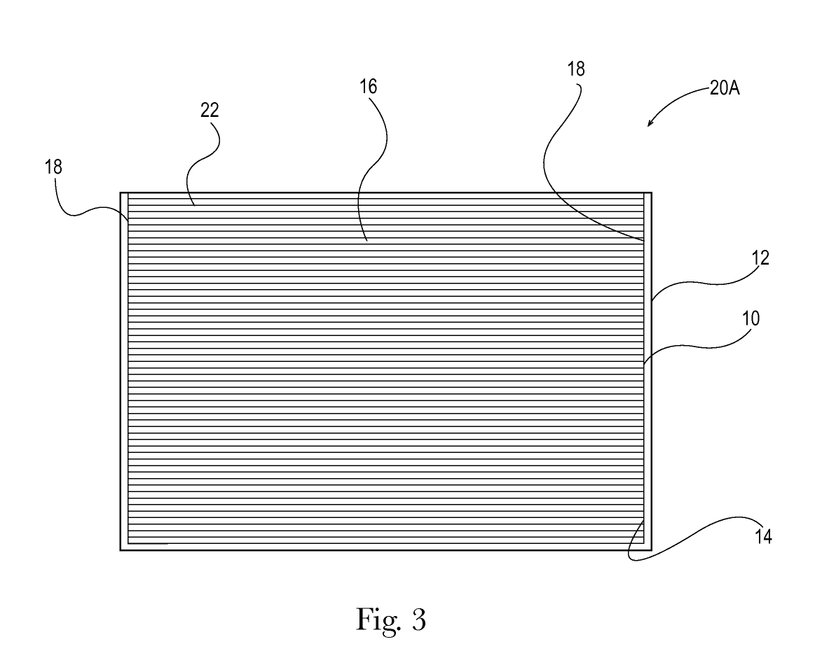

Additionally, as shown in FIG. 3, it may be advantageous to provide an insert 18 within carton 21 to provide for further folded article containment or for additional structural support of the top wall 35. Such an insert 18 may comprise a three-sided structure with one ends and a top portion. An exemplary insert 18 can be formed from a paperboard structure having two parallel fold lines and form a ‘U’ shape. Thus, the exemplary insert 18 would provide a bottom and two side walls relative to the carton 21 when disposed therein. The insert 18 can provide a consumer cognizable benefit by assisting in the upright support of the side walls of the resulting carton 21.

When utilized, insert 18 effectively reduces the paperboard footprint of a traditional paperboard carton by eliminating the need for the additional material necessary to form the end walls and top portion of the traditional tissue container. This results in a synergistic effect by facilitating the sustainable benefit of using less paperboard to produce a traditional tissue container yet provides the additional support that may be necessary if the packaging material 10 is selected to have physical characteristics that may result in the apparent degradation of the appearance of carton 21 upon the consumer removal of the bundle of stacked and/or interleaved sheets 22 disposed within carton 21.

### Test Methods

Unless otherwise specified, all tests described herein including those described under the Definitions section and the following Test Methods are conducted on samples that have been conditioned in a conditioned room at a temperature of 73° F.±4° F. (about 23° C.±2.2° C.) and a relative humidity of 50%±2% for 2 hours prior to the test. All plastic and paper board packaging materials must be carefully separated from any sanitary tissue products contained therein prior to testing. Discard any damaged samples. All tests are conducted in such a conditioned room.

### Package Height Reduction Test Method

A wrapped stack of tissues is placed on a flat surface with in such a manner that the opening of the package is facing upward. In this way product is removed from the top panel of the wrapped package.

If the package has rectangular paralellpiped geometry, before the package is opened and any tissues are dispensed, the height from the flat surface to the top panel at the center point of the longer horizontal (side) panel is measured. If the package has a cubic paralellpiped geometry, before the package is opened and any tissues are dispensed, the height from the flat surface to the top panel at the center point of any of the side panels is measured. This is the measurement point for all data generated for this method.

Next, the dispensing feature is opened and tissues are removed. Take a height measurement at the same center point as any desired amount of tissues are dispensed. It is preferred that a height measurement be taken after the removal of 10 sheets and each 10 sheets thereafter until 100% of sheets disposed within the package are dispensed.

### Plate Stiffness Test Method

As used herein, the “Plate Stiffness” test is a measure of stiffness of a flat sample as it is deformed downward into a hole beneath the sample. For the test, the sample is modeled as an infinite plate with thickness “t” that resides on a flat surface where it is centered over a hole with radius “R”. A central force “F” applied to the tissue directly over the center of the hole deflects the tissue down into the hole by a distance “w”. For a linear elastic material the deflection can be predicted by:

$$w = \frac{3 F}{4 π {Et}^{3}} ( 1 - v ) ( 3 + v ) {R}^{2}$$

where “E” is the effective linear elastic modulus, “v” is the Poisson's ratio, “R” is the radius of the hole, and “t” is the thickness of the tissue, taken as the caliper in millimeters measured on a stack of 5 tissues under a load of about 0.29 psi. Taking Poisson's ratio as 0.1 (the solution is not highly sensitive to this parameter, so the inaccuracy due to the assumed value is likely to be minor), the previous equation can be rewritten for “w” to estimate the effective modulus as a function of the flexibility test results:

$$E \approx \frac{3 {R}^{2}}{4 {t}^{3}} \frac{F}{w}$$

The test results are carried out using an MTS Alliance RT/1 testing machine (MTS Systems Corp., Eden Prairie, Minn.) with a 100N load cell. As a stack of five tissue sheets at least 2.5-inches square sits centered over a hole of radius 15.75 mm on a support plate, a blunt probe of 3.15 mm radius descends at a speed of 20 mm/min. When the probe tip descends to 1 mm below the plane of the support plate, the test is terminated. The maximum slope in grams of force/mm over any 0.5 mm span during the test is recorded (this maximum slope generally occurs at the end of the stroke). The load cell monitors the applied force and the position of the probe tip relative to the plane of the support plate is also monitored. The peak load is recorded, and “E” is estimated using the above equation.

The Plate Stiffness “S” per unit width can then be calculated as:

$$S = \frac{{Et}^{3}}{12}$$

and is expressed in units of Newtons-millimeters. The Testworks program uses the following formula to calculate stiffness:

S=(F/w)[(3+v)R²/16π]

wherein “F/w” is max slope (force divided by deflection), “v” is Poisson's ratio taken as 0.1, and “R” is the ring radius.

In a non-limiting example, a material suitable for forming a carton 21 may preferably exhibit a plate stiffness value ranging from about 1.4 N/mm to about 200 N/mm, or from about 1.4 N/mm to about 50 N/mm, or from about 1.4 N/mm to about 25 N/mm.

### Elevation Test Method

An elevation of a surface pattern or portion of a surface pattern on a structure can be measured using a GFM Mikrocad Optical Profiler instrument commercially available from GFMesstechnik GmbH, Warthestraβe 21, D14513 Teltow/Berlin, Germany. The GFM Mikrocad Optical Profiler instrument includes a compact optical measuring sensor based on the digital micro mirror projection, consisting of the following main components: a) DMD projector with 1024×768 direct digital controlled micro mirrors, b) CCD camera with high resolution (1300×1000 pixels), c) projection optics adapted to a measuring area of at least 44 mm×33 mm, and d) matching resolution recording optics; a table tripod based on a small hard stone plate; a cold light source; a measuring, control, and evaluation computer; measuring, control, and evaluation software ODSCAD 4.0, English version; and adjusting probes for lateral (x-y) and vertical (z) calibration.

The GFM Mikrocad Optical Profiler system measures the surface height of a product sample using the digital micro-mirror pattern projection technique. The result of the analysis is a map of surface height (z) vs. xy displacement. The system has a field of view of 140×105 mm with a resolution of 29 microns. The height resolution should be set to between 0.10 and 1.00 micron. The height range is 64,000 times the resolution.

The relative height of different portions of a surface pattern can be visually determined via a topography image, which is obtained for each product sample as described below. At least three samples are measured. Actual height values can be obtained as follows below.

To measure the height or elevation of a surface pattern or portion of a surface pattern, the following can be performed: (1) Turn on the cold light source. The settings on the cold light source should be 4 and C, which should give a reading of 3000K on the display; (2) Turn on the computer, monitor and printer and open the ODSCAD 4.0 or higher Mikrocad Software; (3) Select “Measurement” icon from the Mikrocad taskbar and then click the “Live Pic” button; (4) Place a product sample, of at least 5 cm by 5 cm in size, under the projection head, without any mechanical clamping, and adjust the distance for best focus; (5) Click the “Pattern” button repeatedly to project one of several focusing patterns to aid in achieving the best focus (the software cross hair should align with the projected cross hair when optimal focus is achieved). Position the projection head to be normal to the sanitary tissue product sample surface; (6) Adjust image brightness by changing the aperture on the camera lens and/or altering the camera “gain” setting on the screen. Set the gain to the lowest practical level while maintaining optimum brightness so as to limit the amount of electronic noise. When the illumination is optimum, the red circle at bottom of the screen labeled “I.O.” will turn green; (7) Select Standard measurement type; (8) Click on the “Measure” button. This will freeze the live image on the screen and, simultaneously, the surface capture process will begin. It is important to keep the sample still during this time to avoid blurring of the captured images. The full digitized surface data set will be captured in approximately 20 seconds; (9) Save the data to a computer file with “.omc” extension. This will also save the camera image file “.kam”; (10) Export the file to the FD3 v1.0 format; 11) Measure and record at least three areas from each sample; 12) Import each file into the software package SPIP (Image Metrology, A/S, Horsholm, Denmark); 13) Using the Averaging profile tool, draw a profile line perpendicular to height or elevation (such as embossment) transition region. Expand the averaging box to include as much of the height or elevation (embossment) as practical so as to generate and average profile of the transition region (from top surface to the bottom of the surface pattern or portion of surface pattern (such as an embossment) and backup to the top surface.). In the average line profile window, select a pair of cursor points.

To move the surface data into the analysis portion of the software, click on the clipboard/man icon; (11) Now, click on the icon “Draw Lines”. Draw a line through the center of a region of features defining the texture of interest. Click on Show Sectional Line icon. In the sectional plot, click on any two points of interest, for example, a peak and the baseline, then click on vertical distance tool to measure height in microns or click on adjacent peaks and use the horizontal distance tool to determine in-plane direction spacing; and (12) for height measurements, use 3 lines, with at least 5 measurements per line, discarding the high and low values for each line, and determining the mean of the remaining 9 values. Also record the standard deviation, maximum, and minimum. For x and/or y direction measurements, determine the mean of 7 measurements. Also record the standard deviation, maximum, and minimum. Criteria that can be used to characterize and distinguish texture include, but are not limited to, occluded area (i.e. area of features), open area (area absent of features), spacing, in-plane size, and height. If the probability that the difference between the two means of texture characterization is caused by chance is less than 10%, the textures can be considered to differ from one another.

### Compression/Relaxation Test Method

The Compression Value of a sample product is measured by as follows. Caliper versus load data are obtained using a Thwing-Albert Model EJA Materials Tester, equipped with a 2500 g load cell and compression fixture including a compression table (compression platen). The compression fixture consists of the following: a load cell adaptor/foot mount 1.128 inch diameter presser foot, #89-14 anvil, 89-157 leveling plate, anvil mount, and a grip pin, all available from the Thwing-Albert Instrument Company. The compression foot has an area is 1 in². The instrument is run under the control of Thwing-Albert Motion Analysis Presentation Software (MAP V3.0.5.7). A 4-inch×4-inch test sample in is cut from the material to be tested. Care should be taken to avoid damage to the center portion of the test sample which will be under test. Scissors or other suitable cutting tools may be used. For testing purposes, the test sample is centered on the compression table under the compression foot. The compression-relaxation procedure is performed once on each test sample. The compression and relaxation portion data are obtained using a crosshead speed of 0.10 inches/minute with a data acquisition rate of 50/sec and an approach speed of 0.3 in/min. When the load reaches ≧3 g. the approach speed is reduced to 0.10 in/min. The deflection of the load cell is obtained by running the test without a test sample being present on the compression table. This is generally known to those of skill in the art as the Steel-to-Steel data. The Steel-to-Steel data are obtained at a crosshead speed of 0.10 inch/minute. Crosshead position and load cell data are recorded between the load cell range of 25 g to 1250 g for both the compression and relaxation portions of the test. Since the compression foot area is 1 in this corresponds to a range of 25 g/in² to 1250 g/in². The maximum pressure exerted on the sample is 300 g/in². At 300 g/in² the crosshead reverses its travel direction. Crosshead position values are collected at selected load values during the test. These correspond to pressure values of 25, 50, 75, 100, 125, 150, 200. 300, 400, 500, 600, 750, 1000, 1250, 1250, 1000, 750, 600, 500, 400, 300, 200, 150, 125, 100, 75, 50, and 25 g/in² for the compression and the relaxation directions respectively. During the compression portion of the test, crosshead position values are collected by the MAP software, by defining 14 traps (Trap 1 to Trap 14) at load settings of 25 (C25), 50 (C50), 75 (C75), 100 (C100), 125 (C125), 150 (C150), 200 (C200), 300 (C300), 400 (C400), 500 (C500), 600 (C600), 750 (C750), 1000 (C1000), and 1250 (C1250) g/in². The test apparatus and procedure compresses the test sample between 1500 g/in² to 1600 g/in² before returning. During the relaxation (return) portion of the test, crosshead position values are collected by the MAP software, by defining 14 return traps (Return Trap1 to Return Trap 14) at load settings of 1250 (R1250), 1000 (R1000), 750 (R750), 600 (R600), 500 (R500), 400 (R400), 300 (R300), 200 (R200), 150 (R150), 125 (R125), 100 (R100), 75 (R75), 50 (R50), and 25 (R25) g/in². This cycle of compressions to 1250 g/in² and return to 25 g/in² is on the same test sample without removing the test sample. The compression-relaxation test is replicated 5 times for a given sample and using a fresh material sample each time. The result (caliper of the test sample) is reported as an average of the 5 replicates for a given load. The caliper values are obtained for both the Steel-to-Steel and the test sample. Steel-to-Steel values are obtained for each batch of testing. If multiple days are involved in the testing, the values are checked daily. The Steel-to-Steel values and the test sample values are an average of 5 replicates at a given load.

Caliper values for a sample are obtained by subtracting the average Steel-to-Steel crosshead trap value for a given load from the test sample crosshead trap value for a given load (for example at each trap point). For example, the caliper values from five individual replicates at a given load on each test sample are averaged and used to obtain the Compression Value at a given load. Compression Values are reported in millimeters (mils).

### Results

### Package Height Reduction

TABLE 1
Results of Package Height Reduction for 4 Exemplary
Packages and Calculated Percent Drop.

| | | | 18 gsm non- | | 30 gsm non- | | | |
|---|---|---|---|---|---|---|---|---|
| | 1.5-mil | | woven/1.8-mil | | woven/1.8-mil | | | |
| | Polyethylene (PE) | | PE Micro Emboss | | PE Micro Emboss | | 18 gsm | |
| | Film Only | | (ME) film | | (ME) film | | non-woven (NW) | |
| | Package | | laminate Package | | laminate Package | | Only Package | |
| Sheets | Height | | Height | | Height | | Height | |
| Remaining | (in) | % DROP | (in) | % DROP | (in) | % DROP | (in) | % DROP |
| 100 | 2.375 | n/a | 2.8125 | n/a | 2.75 | n/a | 2.75 | n/a |
| 90 | 2.3125 | 2.6% | 2.8125 | 0.0% | 2.6875 | 2.3% | 2.75 | 0.0% |
| 80 | 2 | 15.8% | 2.8125 | 0.0% | 2.6875 | 2.3% | 2.75 | 0.0% |
| 70 | 1.75 | 26.3% | 2.8125 | 0.0% | 2.6875 | 2.3% | 2.6875 | 2.3% |
| 60 | 1.625 | 31.6% | 2.75 | 2.2% | 2.625 | 4.5% | 2.5 | 9.1% |
| 50 | 1.625 | 31.6% | 2.75 | 2.2% | 2.625 | 4.5% | 2.4375 | 11.4% |
| 40 | 1.25 | 47.4% | 2.75 | 2.2% | 2.625 | 4.5% | 2.4375 | 11.4% |
| 30 | 1 | 57.9% | 2.75 | 2.2% | 2.625 | 4.5% | 2.375 | 13.6% |
| 20 | 0.875 | 63.2% | 2.75 | 2.2% | 2.625 | 4.5% | 2.25 | 18.2% |
| 10 | 0.5 | 78.9% | 2.75 | 2.2% | 2.5625 | 6.8% | 2.25 | 18.2% |
| 0 | 0.25 | 89.5% | 2.75 | 2.2% | 2.5625 | 6.8% | 2.125 | 22.7% |

TABLE 2
Overall Package Height Reduction for 4 Exemplary Packages

| Package Material | Total Drop |
|---|---|
| 1.5-mil PE Film Only | 89.50% |
| 18-gsm NW Only | 22.70% |
| 18 gsm NW + 1.8-mil PE | 2.20% |
| ME Film | |
| 30 gsm NW + 1.8-mil PE | 6.80% |
| ME Film | |

### Plate Stiffness Test

TABLE 3
Overall Plate Stiffness Results for 7 Exemplary Packages
(4 Replicate Samples)

| Sample Name | g/mm | N * mm | max g |
|---|---|---|---|
| 20-mil Coated Recycled Board (CRB) | 2931.023 | 440 | 2666.186 |
| 20-mil Coated Recycled Board (CRB) | 2905.107 | 436 | 2632.053 |
| 20-mil Recycled Board (CRB) | 2812.874 | 422 | 2527.035 |
| 20-mil Recycled Board (CRB) | 3016.858 | 453 | 2754.775 |
| 1.5 ml PE film | 3.894 | 0.584 | 2.825 |
| 1.5 ml PE film | 4.870 | 0.731 | 3.028 |
| 1.5 ml PE film | 5.383 | 0.808 | 3.692 |
| 1.5 ml PE film | 3.808 | 0.571 | 3.004 |
| 1.8-mil PE Micro Emboss (ME) Film | 2.080 | 0.312 | 1.571 |
| 1.8-mil PE Micro Emboss (ME) Film | 1.703 | 0.256 | 1.478 |
| 1.8-mil PE Micro Emboss (ME) Film | 1.956 | 0.293 | 1.526 |
| 1.8-mil PE Micro Emboss (ME) Film | 1.914 | 0.287 | 1.560 |
| 18 gsm non-woven (NW) | 7.333 | 1.100 | 4.872 |
| 18 gsm non-woven (NW) | 4.112 | 0.617 | 3.742 |
| 18 gsm non-woven (NW) | 3.993 | 0.599 | 3.449 |
| 18 gsm non-woven (NW) | 4.900 | 0.735 | 5.103 |
| 30 gsm non-woven (NW) | 3.414 | 0.512 | 2.748 |
| 30 gsm non-woven (NW) | 3.221 | 0.483 | 2.551 |
| 30 gsm non-woven (NW) | 4.701 | 0.705 | 3.118 |
| 30 gsm non-woven (NW) | 4.357 | 0.654 | 3.178 |
| 18 gsm NW + 1.8-mil PE ME film | 19.176 | 2.877 | 13.410 |
| 18 gsm NW + 1.8-mil PE ME film | 15.092 | 2.264 | 11.149 |
| 18 gsm NW + 1.8-mil PE ME film | 9.799 | 1.470 | 8.111 |
| 18 gsm NW + 1.8-mil PE ME film | 16.271 | 2.441 | 12.522 |
| 18 gsm NW + 1.8-mil PE ME film | 18.539 | 2.781 | 12.522 |
| 30 gsm NW + 1.8-mil PE ME film | 15.183 | 2.278 | 11.461 |
| 30 gsm NW + 1.8-mil PE ME film | 16.850 | 2.528 | 12.483 |
| 30 gsm NW + 1.8-mil PE ME film | 16.299 | 2.445 | 12.655 |
| 30 gsm NW + 1.8-mil PE ME film | 18.924 | 2.839 | 13.730 |

### Elevation Test

TABLE 4
Overall Surface Elevation of 3 Exemplary Packages.

| Sample | Sa (μm) | Sq (μm) |
|---|---|---|
| 18gsm-non-woven with | 26.2 | 33.9 |
| 1.8-mil PE ME film | | |
| 30gsm-non-woven with | 36.3 | 45.8 |
| 1.8-mil PE ME film | | |
| 30gsm-non-woven | 37.9 | 47.6 |

### Compression Test

TABLE 5
Results of Compression Data (i.e., Overall Compression and Compressive Force) for
Exemplary Laminated and Non-Laminated Structures.

| | Compression Caliper (mil) | | | | | | | | | | | | | | |
|---|---|---|---|---|---|---|---|---|---|---|---|---|---|---|---|
| | | | | | | | | | | | | | | | C1250 − |
| Sample Name | C25 | C50 | C75 | C100 | C125 | C150 | C200 | C300 | C400 | C500 | C600 | C750 | C1000 | C1250 | C25 |
| 20-pt CRB (paperboard) | 21.48 | 21.06 | 20.94 | 20.80 | 20.71 | 20.70 | 20.64 | 20.52 | 20.51 | 20.50 | 20.40 | 20.40 | 20.36 | 20.37 | −1.12 |
| 20-pt CRB (paperboard) | 20.95 | 20.80 | 20.70 | 20.54 | 20.57 | 20.56 | 20.51 | 20.41 | 20.41 | 20.34 | 20.28 | 20.25 | 20.19 | 20.18 | −0.76 |
| 20-pt CRB (paperboard) | 20.94 | 20.51 | 20.41 | 20.34 | 20.28 | 20.26 | 20.19 | 20.11 | 20.08 | 19.94 | 19.96 | 19.91 | 19.87 | 19.87 | −1.07 |
| 20-pt CRB (paperboard) | 20.75 | 20.34 | 20.31 | 20.23 | 20.18 | 20.14 | 20.07 | 20.01 | 20.00 | 19.89 | 19.88 | 19.84 | 19.85 | 19.83 | −0.92 |
| Norm. 20-pt CRB (paperboard) | 1.00 | 0.98 | 0.97 | 0.97 | 0.96 | 0.96 | 0.96 | 0.96 | 0.95 | 0.95 | 0.95 | 0.95 | 0.95 | 0.95 | −0.97 |
| 30 gsm non-woven/film | 14.40 | 13.87 | 13.54 | 13.30 | 13.12 | 12.96 | 12.69 | 12.34 | 12.09 | 11.87 | 11.68 | 11.50 | 11.20 | 10.97 | −3.43 |
| 30 gsm non-woven/film | 14.68 | 14.12 | 13.76 | 13.45 | 13.31 | 13.07 | 12.82 | 12.46 | 12.15 | 11.91 | 11.72 | 11.49 | 11.15 | 10.98 | −3.70 |
| 30 gsm non-woven/film | 14.42 | 13.89 | 13.53 | 13.26 | 13.11 | 12.90 | 12.62 | 12.21 | 11.96 | 11.74 | 11.54 | 11.28 | 11.00 | 10.80 | −3.62 |
| 30 gsm non-woven/film | 15.39 | 14.74 | 14.31 | 14.05 | 13.83 | 13.58 | 13.39 | 13.00 | 12.73 | 12.49 | 12.31 | 12.11 | 11.81 | 11.60 | −3.79 |
| Norm. 30 gsm non-woven/film | 1.00 | 0.96 | 0.94 | 0.92 | 0.91 | 0.90 | 0.88 | 0.86 | 0.84 | 0.82 | 0.81 | 0.80 | 0.78 | 0.76 | −3.63 |
| Clear micro emb | 2.70 | 2.71 | 2.65 | 2.58 | 2.59 | 2.58 | 2.60 | 2.60 | 2.59 | 2.59 | 2.59 | 2.58 | 2.59 | 2.59 | −0.12 |
| Clear micro emb | 3.14 | 2.97 | 2.97 | 2.92 | 2.83 | 2.72 | 2.72 | 2.68 | 2.61 | 2.59 | 2.61 | 2.58 | 2.59 | 2.57 | −0.57 |
| Clear micro emb | 2.72 | 2.72 | 2.69 | 2.71 | 2.62 | 2.61 | 2.63 | 2.64 | 2.61 | 2.60 | 2.59 | 2.61 | 2.61 | 2.61 | −0.11 |
| Clear micro emb | 2.73 | 2.71 | 2.67 | 2.71 | 2.61 | 2.62 | 2.63 | 2.65 | 2.62 | 2.62 | 2.62 | 2.61 | 2.61 | 2.62 | −0.11 |
| Norm. Clear micro emb | 1.00 | 0.98 | 0.97 | 0.97 | 0.94 | 0.93 | 0.94 | 0.94 | 0.92 | 0.92 | 0.92 | 0.92 | 0.92 | 0.92 | −0.23 |
| 30 gsm non-woven | 11.33 | 10.72 | 10.37 | 10.11 | 9.87 | 9.75 | 9.49 | 9.09 | 8.82 | 8.64 | 8.45 | 8.26 | 7.98 | 7.79 | −3.54 |
| 30 gsm non-woven | 12.17 | 11.52 | 11.12 | 10.87 | 10.63 | 10.45 | 10.15 | 9.80 | 9.49 | 9.25 | 9.09 | 8.85 | 8.58 | 8.41 | −3.76 |
| 30 gsm non-woven | 11.55 | 10.81 | 10.45 | 10.17 | 9.93 | 9.76 | 9.51 | 9.13 | 8.87 | 8.65 | 8.48 | 8.28 | 8.01 | 7.84 | −3.71 |
| 30 gsm non-woven | 11.51 | 10.97 | 10.67 | 10.43 | 10.24 | 10.05 | 9.84 | 9.44 | 9.28 | 9.10 | 8.94 | 8.75 | 8.48 | 8.35 | −3.16 |
| Norm. 30 gsm non-woven | 1.00 | 0.95 | 0.92 | 0.89 | 0.87 | 0.86 | 0.84 | 0.80 | 0.78 | 0.77 | 0.75 | 0.73 | 0.71 | 0.70 | −3.54 |
| 18 gsm non-woven/film | 11.76 | 11.41 | 11.18 | 10.97 | 10.90 | 10.77 | 10.60 | 10.37 | 10.18 | 10.01 | 9.87 | 9.71 | 9.50 | 9.36 | −2.40 |
| 18 gsm non-woven/film | 11.83 | 11.47 | 11.22 | 11.00 | 10.92 | 10.79 | 10.62 | 10.36 | 10.18 | 10.01 | 9.88 | 9.72 | 9.50 | 9.36 | −2.47 |
| 18 gsm non-woven/film | 11.51 | 11.03 | 10.78 | 10.59 | 10.45 | 10.30 | 10.10 | 9.82 | 9.66 | 9.46 | 9.31 | 9.15 | 8.93 | 8.75 | −2.76 |
| 18 gsm non-woven/film | 12.38 | 11.97 | 11.73 | 11.55 | 11.39 | 11.19 | 11.06 | 10.76 | 10.56 | 10.32 | 10.21 | 10.00 | 9.76 | 9.57 | −2.81 |
| Norm. 18 gsm non-woven/film | 1.00 | 0.97 | 0.95 | 0.93 | 0.92 | 0.91 | 0.89 | 0.87 | 0.85 | 0.84 | 0.83 | 0.81 | 0.79 | 0.78 | −2.61 |
| 18 gsm non-woven | 8.48 | 8.16 | 7.92 | 7.75 | 7.61 | 7.51 | 7.36 | 7.10 | 6.96 | 6.82 | 6.70 | 6.53 | 6.34 | 6.24 | −2.24 |
| 18 gsm non-woven | 7.96 | 7.60 | 7.36 | 7.21 | 7.11 | 7.00 | 6.83 | 6.60 | 6.47 | 6.35 | 6.23 | 6.11 | 5.95 | 5.84 | −2.12 |
| 18 gsm non-woven | 9.19 | 8.75 | 8.44 | 8.35 | 8.20 | 8.06 | 7.87 | 7.64 | 7.41 | 7.30 | 7.16 | 7.01 | 6.82 | 6.70 | −2.49 |
| 18 gsm non-woven | 8.41 | 7.97 | 7.82 | 7.66 | 7.53 | 7.39 | 7.27 | 7.01 | 6.91 | 6.79 | 6.69 | 6.51 | 6.34 | 6.23 | −2.18 |
| Norm. 18 gsm non-woven | 1.00 | 0.95 | 0.93 | 0.91 | 0.89 | 0.88 | 0.86 | 0.83 | 0.82 | 0.80 | 0.79 | 0.77 | 0.75 | 0.74 | −2.25 |

TABLE 6
Results of Relaxation Data (i.e., Overall Relaxation and Relaxive Force) for Exemplary
Laminated and Non-Laminated Structures

| | Relaxation Caliper (mil) | | | | | | | |
|---|---|---|---|---|---|---|---|---|
| Sample Name | R1250 | R1000 | R750 | R600 | R500 | R400 | R300 | R200 |
| 20-pt CRB (paperboard) | 20.363 | 20.367 | 20.283 | 20.258 | 20.313 | 20.390 | 20.430 | 20.446 |
| 20-pt CRB (paperboard) | 20.193 | 20.182 | 20.119 | 20.108 | 20.155 | 20.210 | 20.264 | 20.272 |
| 20-pt CRB (paperboard) | 19.873 | 19.868 | 19.791 | 19.781 | 19.807 | 19.904 | 19.911 | 19.954 |
| 20-pt CRB (paperboard) | 19.852 | 19.833 | 19.773 | 19.742 | 19.780 | 19.885 | 19.858 | 19.938 |
| Norm. 20-pt CRB (paperboard) | 0.99 | 0.99 | 0.98 | 0.98 | 0.98 | 0.99 | 0.99 | 0.99 |
| 30 gsm non-woven/film | 11.203 | 10.968 | 10.758 | 10.785 | 10.914 | 11.074 | 11.196 | 11.303 |
| 30 gsm non-woven/film | 11.152 | 10.981 | 10.689 | 10.715 | 10.901 | 11.041 | 11.141 | 11.286 |
| 30 gsm non-woven/film | 11.000 | 10.799 | 10.534 | 10.553 | 10.694 | 10.955 | 10.979 | 11.148 |
| 30 gsm non-woven/film | 11.806 | 11.597 | 11.321 | 11.299 | 11.474 | 11.630 | 11.763 | 11.869 |
| Norm. 30 gsm non-woven/film | 0.92 | 0.90 | 0.88 | 0.88 | 0.89 | 0.91 | 0.92 | 0.93 |
| Clear micro emb | 2.589 | 2.585 | 2.580 | 2.593 | 2.569 | 2.561 | 2.589 | 2.608 |
| Clear micro emb | 2.590 | 2.568 | 2.560 | 2.556 | 2.552 | 2.568 | 2.575 | 2.615 |
| Clear micro emb | 2.605 | 2.612 | 2.588 | 2.570 | 2.585 | 2.571 | 2.602 | 2.642 |
| Clear micro emb | 2.607 | 2.615 | 2.594 | 2.588 | 2.587 | 2.592 | 2.609 | 2.637 |
| Norm. Clear micro emb | 0.97 | 0.97 | 0.96 | 0.96 | 0.96 | 0.96 | 0.97 | 0.98 |
| 30 gsm non-woven | 7.978 | 7.787 | 7.523 | 7.562 | 7.676 | 7.841 | 7.965 | 8.078 |
| 30 gsm non-woven | 8.583 | 8.408 | 8.142 | 8.165 | 8.298 | 8.480 | 8.607 | 8.782 |
| 30 gsm non-woven | 8.014 | 7.836 | 7.594 | 7.602 | 7.725 | 7.912 | 8.029 | 8.161 |
| 30 gsm non-woven | 8.484 | 8.351 | 8.115 | 8.130 | 8.272 | 8.440 | 8.541 | 8.706 |
| Norm. 30 gsm non-woven | 0.88 | 0.86 | 0.84 | 0.84 | 0.85 | 0.87 | 0.89 | 0.90 |
| 18 gsm non-woven/film | 9.504 | 9.364 | 9.138 | 9.134 | 9.264 | 9.416 | 9.534 | 9.626 |
| 18 gsm non-woven/film | 9.500 | 9.363 | 9.121 | 9.096 | 9.240 | 9.369 | 9.512 | 9.637 |
| 18 gsm non-woven/film | 8.929 | 8.748 | 8.575 | 8.581 | 8.718 | 8.844 | 8.923 | 9.051 |
| 18 gsm non-woven/film | 9.756 | 9.573 | 9.330 | 9.340 | 9.484 | 9.675 | 9.735 | 9.864 |
| Norm. 18 gsm non-woven/film | 0.92 | 0.91 | 0.88 | 0.88 | 0.90 | 0.91 | 0.92 | 0.93 |
| 18 gsm non-woven | 6.335 | 6.243 | 6.099 | 6.108 | 6.252 | 6.338 | 6.418 | 6.617 |
| 18 gsm non-woven | 5.954 | 5.840 | 5.718 | 5.699 | 5.774 | 5.940 | 5.995 | 6.086 |
| 18 gsm non-woven | 6.823 | 6.700 | 6.514 | 6.497 | 6.617 | 6.767 | 6.952 | 7.006 |
| 18 gsm non-woven | 6.335 | 6.234 | 6.146 | 6.111 | 6.275 | 6.360 | 6.424 | 6.567 |
| Norm. 18 gsm non-woven | 0.88 | 0.87 | 0.85 | 0.85 | 0.86 | 0.88 | 0.89 | 0.91 |

| | Relaxation Caliper (mil) | | | | | | |
|---|---|---|---|---|---|---|---|
| Sample Name | R150 | R125 | R100 | R75 | R50 | R25 | R25 − R1250 |
| 20-pt CRB (paperboard) | 20.486 | 20.500 | 20.532 | 20.580 | 20.633 | 20.603 | 0.240 |
| 20-pt CRB (paperboard) | 20.332 | 20.398 | 20.398 | 20.457 | 20.464 | 20.562 | 0.369 |
| 20-pt CRB (paperboard) | 19.994 | 20.059 | 20.101 | 20.114 | 20.124 | 20.149 | 0.276 |
| 20-pt CRB (paperboard) | 19.907 | 19.965 | 20.024 | 20.025 | 20.032 | 20.077 | 0.225 |
| Norm. 20-pt CRB (paperboard) | 0.99 | 0.99 | 1.00 | 1.00 | 1.00 | 1.00 | 0.28 |
| 30 gsm non-woven/film | 11.414 | 11.574 | 11.830 | 11.980 | 12.018 | 12.242 | 1.039 |
| 30 gsm non-woven/film | 11.405 | 11.547 | 11.824 | 12.012 | 12.036 | 12.269 | 1.117 |
| 30 gsm non-woven/film | 11.223 | 11.386 | 11.597 | 11.751 | 11.926 | 11.925 | 0.925 |
| 30 gsm non-woven/film | 11.976 | 12.124 | 12.412 | 12.533 | 12.608 | 12.733 | 0.927 |
| Norm. 30 gsm non-woven/film | 0.94 | 0.95 | 0.97 | 0.98 | 0.99 | 1.00 | 1.00 |
| Clear micro emb | 2.605 | 2.647 | 2.678 | 2.694 | 2.635 | 2.622 | 0.033 |
| Clear micro emb | 2.592 | 2.632 | 2.672 | 2.733 | 2.725 | 2.744 | 0.154 |
| Clear micro emb | 2.605 | 2.625 | 2.699 | 2.681 | 2.700 | 2.685 | 0.080 |
| Clear micro emb | 2.615 | 2.656 | 2.736 | 2.693 | 2.661 | 2.657 | 0.050 |
| Norm. Clear micro emb | 0.97 | 0.99 | 1.01 | 1.01 | 1.00 | 1.00 | 0.08 |
| 30 gsm non-woven | 8.281 | 8.384 | 8.645 | 8.817 | 8.881 | 9.043 | 1.065 |
| 30 gsm non-woven | 8.828 | 8.994 | 9.250 | 9.430 | 9.651 | 9.699 | 1.116 |
| 30 gsm non-woven | 8.322 | 8.436 | 8.699 | 8.909 | 9.006 | 9.136 | 1.122 |
| 30 gsm non-woven | 8.765 | 8.924 | 9.148 | 9.364 | 9.545 | 9.560 | 1.076 |
| Norm. 30 gsm non-woven | 0.91 | 0.93 | 0.95 | 0.98 | 0.99 | 1.00 | 1.09 |
| 18 gsm non-woven/film | 9.737 | 9.881 | 10.025 | 10.167 | 10.203 | 10.262 | 0.758 |
| 18 gsm non-woven/film | 9.677 | 9.832 | 10.093 | 10.125 | 10.173 | 10.273 | 0.773 |
| 18 gsm non-woven/film | 9.133 | 9.296 | 9.459 | 9.622 | 9.837 | 9.814 | 0.885 |
| 18 gsm non-woven/film | 9.965 | 10.092 | 10.309 | 10.440 | 10.482 | 10.566 | 0.810 |
| Norm. 18 gsm non-woven/film | 0.94 | 0.96 | 0.97 | 0.99 | 0.99 | 1.00 | 0.81 |
| 18 gsm non-woven | 6.618 | 6.747 | 6.985 | 7.147 | 7.109 | 7.206 | 0.871 |
| 18 gsm non-woven | 6.182 | 6.319 | 6.466 | 6.543 | 6.626 | 6.731 | 0.777 |
| 18 gsm non-woven | 7.107 | 7.224 | 7.460 | 7.608 | 7.629 | 7.741 | 0.918 |
| 18 gsm non-woven | 6.589 | 6.715 | 6.881 | 6.992 | 7.034 | 7.162 | 0.827 |
| Norm. 18 gsm non-woven | 0.92 | 0.94 | 0.96 | 0.98 | 0.98 | 1.00 | 0.85 |

TABLE 7
Mathematically Expressed Equations for Exemplary Laminated and
Non-Laminated Structures Where x = Compression Pressure and
y = Normalized Compression Caliper.

| | |
|---|---|
| 20-pt CRB (paperboard): | y = −0.012ln(x) + 1.0272 |
| 30 gsm Non-Woven: | y = −0.078ln(x) + 1.2525 |
| 18 gsm non-woven/film: | y = −0.057ln(x) + 1.1892 |
| 30 gsm non-woven/film: | y = −0.061ln(x) + 1.2042 |
| 18 gsm Non-Woven: | y = −0.068ln(x) + 1.2219 |
| Clear micro-emboss: | y = −0.021ln(x) + 1.0598 |
| 30 gsm Non-Woven: | y = −0.078ln(x) + 1.2525 |

TABLE 8
Mathematically Expressed Equations for Exemplary Laminated and
Non-Laminated Structures Where x = Relaxation Pressure and
y = Normalized Relaxation Caliper.

| | |
|---|---|
| 18 gsm non-woven/film: | y = −0.031ln(x) + 1.1058 |
| 30 gsm non-woven/film: | y = −0.031ln(x) + 1.0997 |
| 18 gsm Non-Woven: | y = −0.042ln(x) + 1.1402 |
| 30 gsm Non-Woven: | y = −0.043ln(x) + 1.1413 |

The dimensions and values disclosed herein are not to be understood as being strictly limited to the exact numerical dimension and/or value recited. Instead, unless otherwise specified, each such dimension and/or value is intended to mean both the recited dimension and/or value and a functionally equivalent range surrounding that dimension and/or value. For example, a dimension disclosed as “40 mm” is intended to mean “about 40 mm.”

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A material for forming a container suitable for containing a sanitary tissue product, said material being formed from a fibrous structure bonded to a film material, said material having a Surface Elevation value of greater than 26.2 μm.

2. The material of claim 1 wherein said material has a Surface Elevation value of greater than 36.3 μm.

3. The material of claim 1 wherein said material has a plate stiffness value ranging from about 1.4 N*mm to about 200 N*mm.

4. The material of claim 3 wherein said material has a plate stiffness value ranging from about 1.4 N*mm to about 50 N*/mm.

5. The material of claim 4 wherein said material has a plate stiffness value ranging from about 1.4 N*mm to about 25 N*/mm.

6. The material of claim 1 wherein said material has a normalized Compression value of greater than 2.61.

7. The material of claim 1 wherein said material has a normalized Compression value of greater than 3.54.

8. The material of claim 1 wherein said material has a normalized compression caliper to compression pressure relationship expressed by the equation y=−0.0571 n(x)+1,1892.

9. The material of claim 8 wherein said material has a normalized compression caliper to compression pressure relationship expressed by the equation y=−0.0611 n(x)+1,2042.

10. A material for forming a container suitable for containing a sanitary tissue product, said material being formed from a fibrous structure bonded to a film material, said material having a plate stiffness value ranging from about 1.4 N*mm to about 200 N*mm.

11. The material of claim 10 wherein said plate stiffness value ranges from about 1.4 N*mm to about 50 N*mm.

11. (canceled)

12. The material of claim 10 wherein said material has a normalized Compression value of greater than 2.61.

13. The material of claim 12 wherein said material has a normalized Compression value of greater than 3.54.

14. The material of claim 10 wherein said material has a normalized compression caliper to compression pressure relationship expressed by the equation y=−0.0571 n(x)+1.1892.

15. A material for forming a container suitable for containing a sanitary tissue product, said material comprising a fibrous structure, said fibrous structure having a normalized compression caliper to compression pressure relationship expressed by the equation y=−0.068 n(x)+1.2219.

16. The material of claim 15 wherein said fibrous structure has a normalized compression caliper to compression pressure relationship expressed by the equation y=−0.0571 n(x)+1.1892.

17. The material of claim 15 wherein said fibrous structure has a normalized relaxation caliper to relaxation pressure relationship expressed by the equation y=−0.0311 n(x)+1.1058.

18. The material of claim 17 wherein said fibrous structure has a normalized relaxation caliper to relaxation pressure relationship expressed by the equation y=−0.0311 n(x)+1.0997.

19. The material of claim 15 wherein said material has a plate stiffness value ranging from about 1.4 N*mm to about 200 N*mm.

20. Use material of claim 15 wherein said material has a Surface Elevation value of greater than 26.2 μm.
